(19) United States
(12) Patent Application Publication
(10) Pub. No.: US 2004/0051694 A1
(43) Pub. Date: Mar. 18, 2004

(54) Portable device for inputting control signals to a peripheral unit, and use of such a device

(76) Inventors: Jonas Backman, Danderyd (SE); Kurt Hognelid, Bromma (SE); Fredrik Madsen, Stockholm (SE); Magnus Schnurer, Bromma (SE); Tomas Oquist, Upplands Vasby (SE)

Correspondence Address: Richard R Michaud, McCormick Paulding & Huber, City Place ll, 185 Asylum Street, Hartford, CT, 06103, US

(21) Appl. No.: 10/250,541

(22) PCT Filed: Dec. 27, 2001
(86) PCT No.: PCT/SE01/02911

(30) Foreign Application Priority Data
Jan. 3, 2001 (SE) 0100016-5
Jun. 29, 2001 (SE) 0102343-1
Sep. 14, 2001 (SE) 0103056-8

(51) Int. Cl. G09G 5/00

(52) U.S. Cl. 345/156

(57) ABSTRACT

The invention concerns a portable device for inputting control signals to a peripheral unit. The device comprises a holding member designed to be attached to a first hand of a user of the device so as to retain the device in a predetermined manner on said first hand. At least a first input member is arranged on said holding member. The first input member is arranged for inputting signals to the peripheral unit in order to perform the same or a similar function as a joystick or as the movement of a standard computer mouse. Said input member is arranged on said holding member such that when the holding member is arranged as intended on said first hand, the first input member is arranged within a predetermined area of said first hand. The invention also concerns the use of such a device.

### BACKGROUND OF THE INVENTION

The present invention concerns a portable device for inputting control signals to a peripheral unit, the device comprising:

a holding member designed to be attached to a first hand of a user of the device so as to retain the device in a predetermined manner on said first hand,

at least a first input member arranged on said holding member for inputting signals to the peripheral unit in order to perform the same or a similar function as a joystick or as the movement of a standard computer mouse.

The invention also concerns the use of such a device.

It should be noted that the “first input member” according to the present invention is arranged to fulfil the same function as a standard computer mouse, a joystick, a track-ball or similar device. The input member may thus be used to move a cursor, an arrow or other computer controlled entity in different directions.

A portable device as described above is known from, for example, U.S. Pat. No. 5,832,296. This document describes a device that preferably is worn as a ring around a finger of a hand of a user. The device may fulfil the same function as a standard computer mouse (see column 7, lines 6-18). The device is designed to be operated by the thumb of the same hand on which the device is worn.

EP-A2-789 320 describes other examples of a hand held computer mouse. According to one example, the computer mouse is arranged on a finger. According to another example, the computer mouse is held in the hand.

WP 96/39679 describes a portable input device to be worn around a finger of a user. The device may comprise a micro joystick.

EP-A1-696014 describes an input device to be worn on the thumb and operated by the index finger of the same hand.

A standard computer mouse is of course also known. Such a computer mouse is designed to be moved over a surface. The movement in different directions is detected and transformed into electrical signals used to move, for example, a cursor or pointing arrow on a computer screen.

The above described input devices have certain disadvantages. The standard computer mouse restricts the user to operate the mouse on a desk or other support surface. The use of such a computer mouse may cause strain on the arm and hand used to operate the mouse. This may lead to injuries. The devices described above, in which the computer mouse is attached to a hand, are designed such that the mouse is operated by the same hand on which the mouse is attached. This design often makes it strenuous and difficult to operate the mouse efficiently.

### SUMMARY OF THE INVENTION

An object of the invention is to provide a device of the kind described in the first paragraph above, which device should be easy and comfortable to use. A further object is to provide such a device which may be used in different working positions, such that the user is not bound to use the device while sitting down in front of a desk. Another object is to provide such a device which is advantageous from an ergonomic point of view. Further objects and advantages of the present invention will become clear from the description below.

According to a first aspect of the invention, the above objects are achieved by a portable device of the kind described in the first paragraph above, wherein said first input member is arranged on said holding member such that when the holding member is arranged as intended on said first hand, the first input member is not arranged on any of the fingers but within an area on said first hand that is, when the hand is seen as lying flat on a flat surface with the fingers kept straight, substantially either on the back of the hand including the lower portion of the thumb and extending to and including the outer boundary of the thumb or in the region between the thumb and the part of the side of the hand located closest to the thumb, and wherein the position of the first input member is such that the first input member is easily manipulated by one or more fingers of the second hand of the user.

With such a position of the first input member, the device is comfortable and easy to use. Furthermore, such a position of the first input member allows the fingers of said first hand to be used for other purposes as well, since the holding member and the first input member do normally not interfere with the movement of the fingers on said first hand.

According to a preferred embodiment of the invention, the first input member is arranged in that part of said area that is located closer to the thumb than a line defined by the extension of the middle finger on the back of the hand. Such a location of the first input member has been found to be particularly advantageous for the user.

According to another embodiment, the device comprises at least a second input member arranged on said holding member. Such a further input member has the advantage that other input signals can be generated with the help of the device.

Preferably, the second input member has the function of at least one of the click-buttons on a standard computer mouse.

According to one embodiment, said first and second input members are arranged on said holding member such that, when the holding member is arranged as intended on said first hand, the distance between the second input member and the thumb of the first hand is larger than the distance between the first input member and the thumb of the first hand, such that the second input member may be operated by the index finger or middle finger of said second hand while the first input member is operated by the thumb of said second hand. It has been found to be very easy and comfortable to operate said first and second input members when they are so arranged on said holding member.

According to another embodiment, said first and second input members are arranged on said holding member such that, when the holding member is arranged as intended on said first hand, the distance between the first input member and the thumb of the first hand is larger than the distance between the second input member and the thumb of the first hand, such that the second input member may be operated by the thumb of said second hand while the first input member is operated by the index finger or middle finger of said second hand. As an alternative, it has also been found to be easy to use the device if the thumb is used for the second input member while the index finger or the middle finger are used to operate the first input member, i.e. the “mouse-button”.

According to a further embodiment, the device comprises at least a third input member arranged on said holding member. By having a further input member, further control signals may be transmitted to the peripheral unit.

According to a still further embodiment, at least both the first and the second input members are positioned such that, when the holding member is arranged as intended on said first hand, the first and second input members are located within said area. It has been found to be comfortable to use the device if not only the first input member but also at least the second input member is located within the defined area.

According to a further embodiment, the device comprises at least one input member which is positioned on said holding member and which is arranged to fulfil the same function as a scroll-wheel on a standard computer mouse.

According to a further embodiment, the portable device comprises one or more input members that are so positioned on said holding member that, when the holding member is arranged as intended on said first hand, said one or more input members are located on the inside of said first hand such that they may be manipulated by one or more fingers of said first hand. It has been found to be easy and comfortable to operate input members that are so positioned. The input members located on the inside of the hand may for example include one or more of said click buttons and/or the scroll-wheel.

According to a further embodiment, the device comprises a transmitter unit arranged for transmitting said control signals to the peripheral unit in a wireless manner. Although, according to another embodiment, the device may be connected to the peripheral unit by means of a cable, it is advantageous if the communication with the peripheral device is wireless.

According to still a further embodiment, the holding member comprises a U-shaped portion, which thus has first and second at least relatively straight parts and a bent part connecting said first and second parts, wherein said device is designed to be attachable to said first hand such that the first part is located essentially on the back of the hand, the second part is located essentially on the front of the hand while the bent part extends from the back of the hand to the front of the hand in the area between the thumb and the index finger of said first hand. Such a holding member is easy to attach to the hand and also easy to remove from the hand. Furthermore, such a holding member is comfortable to wear.

According to a further embodiment, said first input member comprises a camera unit arranged in said holding member, wherein said camera unit is positioned to sense the direction of movement of a finger of the user over the portable device in order to generate said signals to the peripheral unit in order to perform said function of the first input member. The “mouse-function” may thus be performed by moving a finger across the device, for example across a small camera window. This embodiment has the advantage that there is no need for any movable or mechanical parts for carrying out the “mouse-function”.

A second aspect of the invention concerns the use of a device according to any of the above embodiments. According to this use, the holding member is attached to said first hand such that said first input member is arranged within said area of the first hand. Thereby, it is comfortable to use the device. The advantages with such a use is clear from the above discussion in connection with the device.

According to a further advantageous use, one or more fingers of said second hand of the user are used to operate said first input member. Also the advantage of such a use has been discussed above.

According to a further use, at least a majority of the fingers of said first hand are kept straight or folded when said one or more fingers of said second hand are used to operate said first input member and wherein at least a plurality of the fingers of the second hand are held on top of the said fingers of the first hand. It has been found that such a use is particularly comfortable for the user.

According to another use, at least a majority of the fingers of said first hand are kept interlaced with fingers of the second hand when said one or more fingers of said second hand are used to operate said first input member. Also this manner of operating the device has been found to be ergonomically advantageous and comfortable.

### SHORT DESCRIPTION OF THE DRAWINGS

FIG. 1 shows a schematic example of a device according to the invention attached to a hand of a user.

FIG. 2 indicates the area of the hand of a user within which the first input member is arranged.

FIG. 3 shows schematically a cross-section of the hand with an attached device in the section marked with A-A in FIG. 1.

FIG. 4 shows a similar section as FIG. 3 of another embodiment of the device.

FIG. 5 shows schematically another example of the design of the device in a cross-section similar to that of FIG. 3 and 4.

FIG. 6 shows schematically another example of the design of a part of the device according to the invention in cross-sections similar to that of FIG. 3 to 5.

FIGS. 7 and 8 illustrate different manners of using the device of the invention.

### DESCRIPTION OF EMBODIMENTS OF THE INVENTION

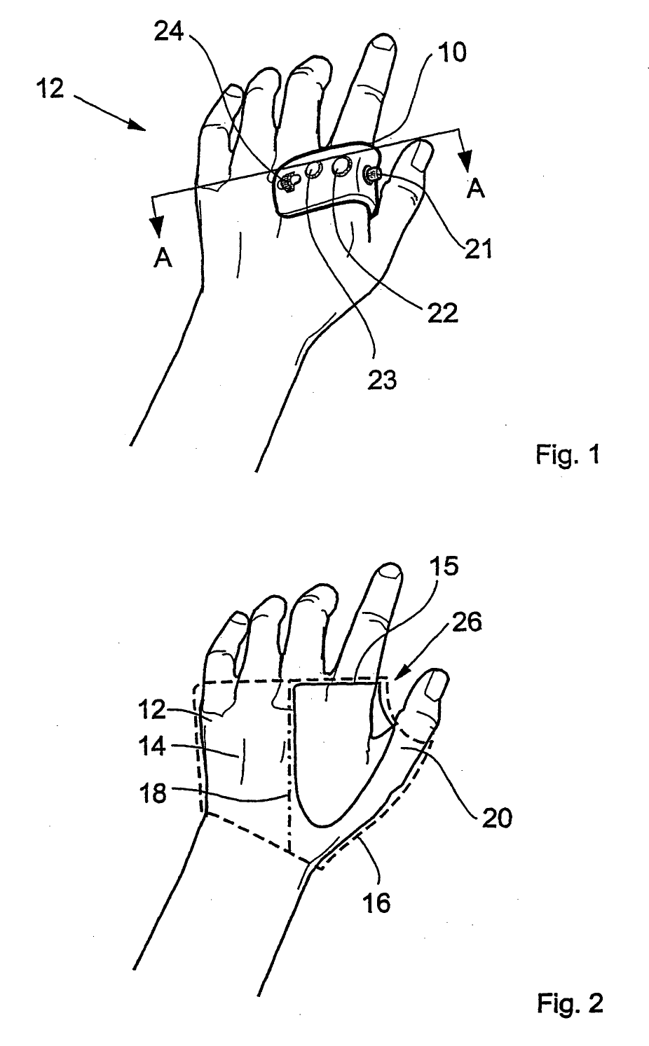

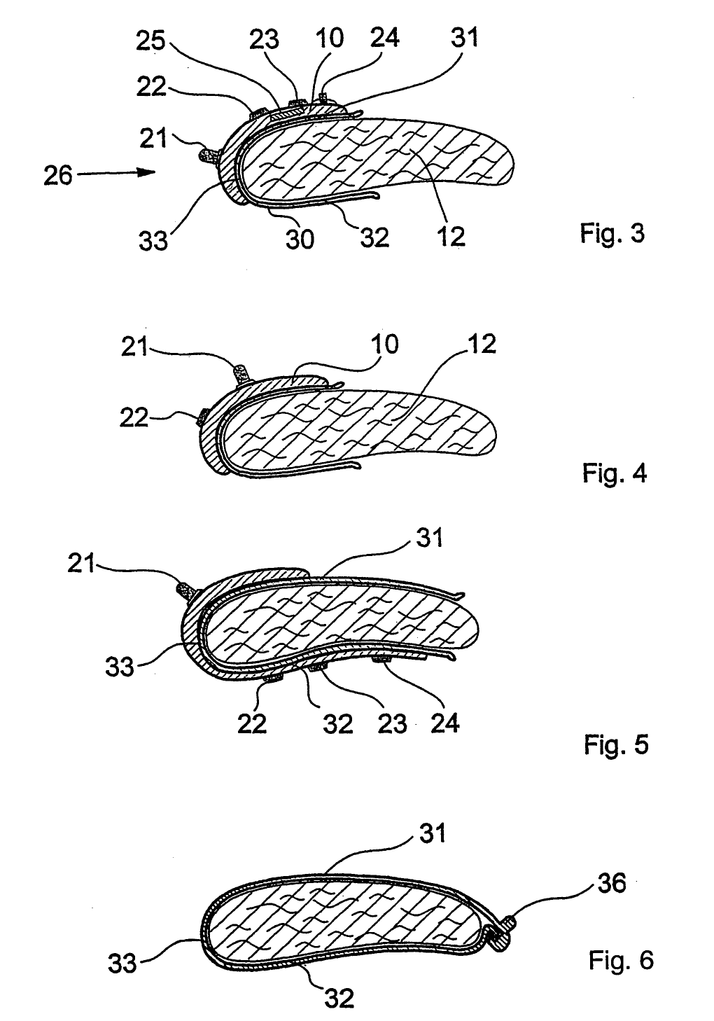

The invention will now be described with particular reference to FIG. 1 and FIG. 3 (for the sake of simplicity, the thumb is not shown in FIGS. 3-6). FIG. 1 shows the back of a first hand 12 of a user to which the device according to the invention is attached. In this case the first hand 12 is the left hand. The device comprises a holding member 10 which is particularly designed to be attached to said first hand 12 of a user. The holding member 10 is designed so as to retain the device in a pre-determined manner on said hand 12. The device comprises at least a first input member 21. This input member 21 is arranged to fulfil the function of a joystick or a computer mouse or a similar device. This means that the first input member 21 may be used to move a cursor or other graphical entity on a computer screen in different directions on said computer screen. The first input member 21 may also be used to control a TV-game, a personal digital assistant (PDA) or other devices. The first input member 21 may be a small joystick, track-point™, ball, plate with capacitive or resistive sensing, or any other kind of means for fulfilling the function of a computer mouse.

The device is designed such that when the holding member 10 is arranged as intended on the hand 12, the first input member 21 is arranged within a pre-determined area 14 of said hand 12. This predetermined area 14 is the area within the broken lines in FIG. 2, including the region 26 between the thumb and the part of the side of the hand 12 located closest to the thumb. The area 14 extends to and includes the outer boundary 16 of the thumb. The area 14 includes also the lower portion 20 of the thumb. The first input member 21 is positioned such that it is easy to operate the first input member 21 with one or more fingers of the second hand, for example with the thumb or the index finger of the second hand. This means, that if the device is arranged on the left hand of the user, the input member 21 may be operated with, for example, the thumb or index finger of the right hand of the user and vice versa. It is of course also possible to operate the first input member 21 with two fingers of the other hand, for example with both the thumb and the index finger. The area to the right of the broken line with dots 18 has been found to be a particularly advantageous area within which the first input member 21 may be positioned. A further preferred such area is the area within the unbroken line 15 in FIG. 2.

The device may include further input members. FIG. 1 and FIG. 3 show a second input member 22 and a third input member 23. The input members 22 and 23 could, for example, be arranged to fulfil the same function as the normal two click-buttons on a standard computer mouse. FIG. 1 and FIG. 3 also show a further input member 24 positioned on the holding member 10. The input member 24 is arranged to fulfil the same function as a scroll-wheel on a standard computer mouse.

As can be seen in FIGS. 1 and 3, the input members are arranged such that the distance between the second input member 22 and the thumb of the hand 12 is larger than the distance between the first input member 21 and the thumb of the hand 12. The third input member 23 is in this embodiment positioned further away from the thumb. This arrangement makes it possible for a user of the device to operate the first input member 21 with the thumb of the other hand (in this case the right hand) at the same time as the second 22 and third 23 input members may be operated by the index finger and the middle finger, respectively, of the right hand.

An alternative embodiment is shown in FIG. 4. Also this figure shows a similar cross-section to that of FIG. 3 of the left hand of a user with a device according to the invention attached to the hand. In this embodiment the distance between the first input member 21 and the thumb of the hand 12 is larger than the distance between the second input member 22 and the thumb of the hand 12. This makes it possible to for example operate the second input member 22 with the thumb of the right hand while the first input member 21 may be operated by the index finger or the middle finger of the right hand.

According to the embodiments shown in FIGS. 1-4, inter alia both the first input member 21 and the second input member 22 are positioned within the area 14 shown in FIG. 2.

The device according to the invention may of course comprise suitable electronics for generating the control signals and for communicating with the peripheral unit. FIG. 3 shows schematically a transmitter unit 25 arranged for transmitting control signals to the peripheral unit in a wireless manner. The communication may for example be via a radio link or an optical link. The device may of course also comprise a battery. According to an alternative solution, the device communicates with the peripheral device via an electrical cable. The device may also include a memory so that information may be inputted to the device and stored in the memory instead of being directly transmitted to the peripheral unit.

The first input member 21 shown on FIGS. 1, 3 and 4 has the form of a small joystick or track-point. However, the first input member 21 may, as have been mentioned above, have any design that can fulfil a “mouse function”. According to one preferred alternative, the first input member 21 may comprise a camera (not shown) arranged in the holding member 10. The camera is arranged to sense the movement of for example a finger of the user across an opening or a camera window arranged in the holding member 10 in order to perform the “mouse-function”. This camera window or opening is of course positioned within the area 14 when the holding member 10 is arranged as intended on the hand 12. It may be noted that such a device with a camera may also be arranged to sense the fingerprint of the user in order to check the identity of the user and in order to check whether the user is entitled to have access to the portable device or to the peripheral unit with which the device communicates.

The device according to the invention may be attached to the hand 12 in different manners. The device may for example be attached with a band that extends around the hand 12 of the user. The holding member 10 may also be formed as a glove, or as part of a glove to be arranged on the hand 12. The device may be attached to the hand in any other manner in which the device is safely held to the hand 12 in a manner such that the first input member 21 is within the defined area 14. FIGS. 1, 3 and 4 show one example of an advantageous manner in which the device may be attached to the hand 12. As can be seen in FIG. 3, the holding member 10 comprises a U-shaped portion 30, which thus has first 31 and second 32 relatively straight parts and a bent part 33 connecting the first 31 and second 32 parts. The U-shaped portion is designed to be attachable to the hand 12 such that the first part 31 is located essentially on the back of the hand 12, the second part 32 is located essentially on the front of the hand 12 while the bent part 33 extends from the back of the hand 12 to the front of the hand 12 in the region between the thumb and the index finger of the hand 12 (see also FIG. 1). The U-shaped portion may be formed to be somewhat flexible such that the device can easily be slid onto the hand 12 and retained on the hand by said U-shaped portion 30. In the shown embodiment the two parts 31 and 32 have substantially the same length. This is however not necessary. It is also possible that one of the parts 31, 32 is substantially longer than the other part. Furthermore, the device may include other portions in addition to the U-shaped portion 30. For example, the device may include a portion that extends from the U-shaped portion 30 and that covers a larger part of the back of the hand 12.

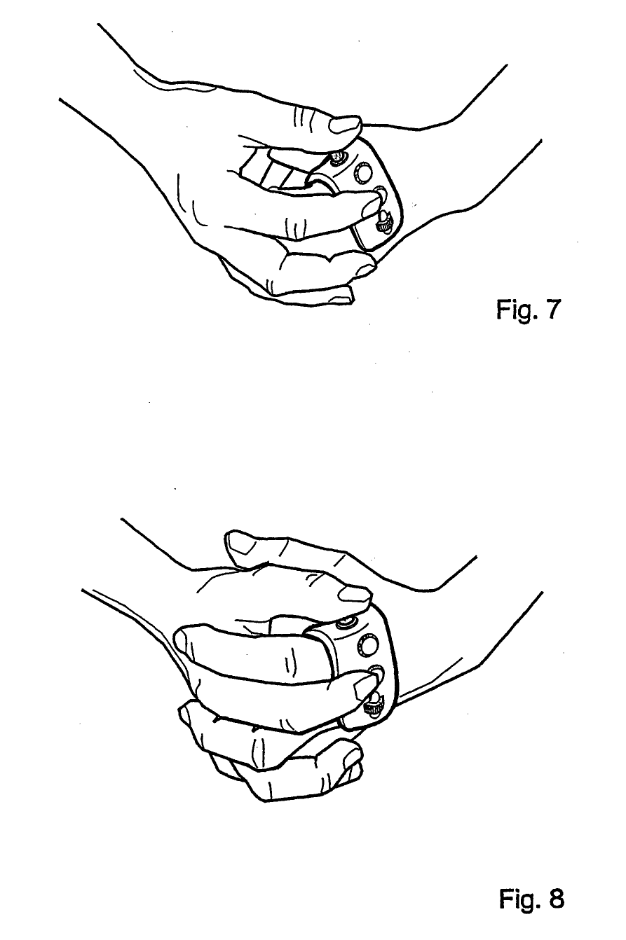

A use according to the invention is characterised in that the holding member 10 is attached to the hand 12 such that the first input member 21 is arranged within the area 14. A preferred manner of using the device is to use one or more fingers (for example the thumb and/or the index finger) of the second hand (in this case the right hand) for operating the first input member 21. This can be done, as illustrated on FIG. 7, by keeping at least a majority of the fingers of the left hand 12 folded when the thumb and/or index finger of the right hand are used to operate the first input member 21, and wherein at least a plurality of the fingers of the right hand are held on top of the folded fingers of the left hand 12. This manner of operating device is found to be particularly comfortable. The device could also be operated in the described manner but while keeping the fingers of the first hand 12 straight.

An alternative manner of operating device, shown on FIG. 8, is to keep at least a majority of the fingers of the left hand 12 interlaced with fingers of the right hand when one or more fingers (for example the thumb or the index finger) of the right hand are used to operate the first input member 21.

When the device is attached to a certain hand 12, the operation of the first input member 21 may be caused by the relative movement of the two hands. This means that in addition to the movement of for example the thumb of the other hand, also the movement of the first hand 12 may contribute to the operation of the input member 21.

In the discussed embodiments, the device according to the invention is attached to the left hand and operated by the right hand. It is of course also possible that the device is designed to be attached to the right hand and operated by the left hand.

The above described manners of using the portable device according to the invention are preferred manners of using the same. Alternative manners of using the device are possible. For example, the holding member 10 may be attached to the first hand 12, but the first input member 21 may still be manipulated with the thumb of this first hand 12. This may for example be possible if the first input member 21 has an appropriate length and is appropriately positioned within the defined area 14. A user may of course also remove the portable device from the intended position on the first hand 12 and use the device by holding it in other manners.

FIG. 5 and FIG. 6 show further examples of how the U-shaped holding portion 30 may be designed. According to FIG. 5 this U-shaped portion 30 extends further across the hand 12 of the user. This makes it possible to make room for more input members on the device. FIG. 6 shows that the U-shaped portion 30 extends all the way across the hand. The device is here provided with a fixation member 36 designed to connect the ends of the first 31 and second 32 parts of the U-shaped portion 30 in order to hold the device securely on the hand.

It should be noted that the device may include further input members or alternative positions of the input members. FIG. 5 illustrates that input members 22, 23 and 24 (which may constitute the two click-buttons and the scroll-wheel) could instead be positioned on the inside of the hand, i.e. in the shown embodiment on the part 32, and be operated by fingers of the first hand (in this case the left hand) at the same time as the first input member 21 is operated by a finger of the second hand. The device may of course include further input members positioned at different parts of the device.

The U-shaped portion 30 may be made of the same material as and form a single unit with the rest of the holding member 10. Alternatively, the U-shaped portion may be made separate from the rest of the holding member 10 and fixed to the rest of the holding member 10.

When in this document a hand or a normal hand is mentioned, it is primarily referred to a hand of a normal size of a grown-up person. The portable device according to the invention could however be fabricated in different sizes for different hands.

The invention is not limited to the described embodiments and the described use but may be varied and modified within the scope of the following claims.

1. A portable device for inputting control signals to a peripheral unit, the device comprising:
a holding member (10) designed to be attached to a first hand (12) of a user of the device so as to retain the device in a predetermined manner on said first hand (12),
at least a first input member (21) arranged on said holding member (10) for inputting signals to the peripheral unit in order to perform the same or a similar function as a joystick or as the movement of a standard computer mouse,
wherein said first input member (21) is arranged on said holding member (10) such that when the holding member (10) is arranged as intended on said first hand (12), the first input member (21) is not arranged on any of the fingers but within an area (14) on said first hand (12) that is, when the hand (12) is seen as lying flat on a flat surface with the fingers kept straight, substantially either on the back of the hand (12) including the lower portion (20) of the thumb and extending to and including the outer boundary (16) of the thumb or in the region (26) between the thumb and the part of the side of the hand located closest to the thumb, and wherein the position of the first input member (21) is such that the first input member (21) is easily manipulated by one or more fingers of the second hand of the user.

2. A portable device according to claim 1, wherein the first input member (21) is arranged in that part of said area (14) that is located closer to the thumb than a line (18) defined by the extension of the middle finger on the back of the hand (12).

3. A portable device according to claim 1 or 2, wherein the device comprises at least a second input member (22) arranged on said holding member (10).

4. A portable device according to claim 3, wherein the second input member (22) has the function of at least one of the click-buttons on a standard computer mouse.

5. A portable device according to claim 3 or 4, wherein said first (21) and second (22) input members are arranged on said holding member (10) such that, when the holding member (10) is arranged as intended on said first hand (12), the distance between the second input member (22) and the thumb of the first hand (12) is larger than the distance between the first input member (21) and the thumb of the first hand (12), such that the second input member (22) may be operated by the index finger or middle finger of said second hand while the first input member (21) is operated by the thumb of said second hand.

6. A portable device according to claim 3 or 4, wherein said first (21) and second (22) input members are arranged on said holding member (10) such that, when the holding member (10) is arranged as intended on said first hand (12), the distance between the first input member (21) and the thumb of the first hand (12) is larger than the distance between the second input member (22) and the thumb of the first hand (12), such that the second input member (22) may be operated by the thumb of said second hand while the first input member (21) is operated by the index finger or middle finger of said second hand.

7. A portable device according to any of the claims 3-6, wherein the device comprises at least a third input member (23) arranged on said holding member (10).

8. A portable device according to any of the claims 3-7, wherein at least both the first (21) and the second (22) input members are positioned such that, when the holding member (10) is arranged as intended on said first hand (12), the first (21) and second (22) input members are located within said area (14).

9. A portable device according to any of the claims 3-8, wherein the device comprises at least one input member (24) which is positioned on said holding member (10) and which is arranged to fulfil the same function as a scroll-wheel on a standard computer mouse.

10. A portable device according to any of the claims 3-9, comprising one or more input members that are so positioned on said holding member (10) that, when the holding member (10) is arranged as intended on said first hand (12), said one or more input members are located on the inside of said first hand (12) such that they may be manipulated by one or more fingers of said first hand (12).

11. A portable device according to any of the preceding claims, comprising a transmitter unit (25) arranged for transmitting said control signals to the peripheral unit in a wireless manner.

12. A portable device according to any of the preceding claims, wherein the holding member (10) comprises a U-shaped portion (30), which thus has first (31) and second (32) at least relatively straight parts and a bent part (33) connecting said first (31) and second (32) parts, wherein said device is designed to be attachable to said first hand (12) such that the first part (31) is located essentially on the back of the hand (12), the second part (32) is located essentially on the front of the hand (12) while the bent part (33) extends from the back of the hand (12) to the front of the hand (12) in the region between the thumb and the index finger of said first hand (12).

13. A portable device according to any of the preceding claims, wherein said first input member (21) comprises a camera unit arranged in said holding member (10), wherein said camera unit is positioned to sense the direction of movement of a finger of the user over the portable device in order to generate said signals to the peripheral unit in order to perform said function of the first input member (21).

14. Use of a portable device according to any of the preceding claims, wherein the holding member (10) is attached to said first hand (12) such that said first input member (21) is arranged within said area (14) of the first hand (12).

15. A use according to claim 14, wherein one or more fingers of said second hand of the user are used to operate said first input member (21).

16. A use according to claim 15, wherein at least a majority of the fingers of said first hand (12) are kept straight or folded when said one or more fingers of said second hand are used to operate said first input member (21) and wherein at least a plurality of the fingers of the second hand are held on top of said fingers of the first hand (12).

17. A use according to claim 15, wherein at least a majority of the fingers of said first hand (12) are kept interlaced with fingers of the second hand when said one or more fingers of said second hand are used to operate said first input member (21).
